(19) United States
(12) Patent Application Publication
(10) Pub. No.: US 2011/0167109 A1
(43) Pub. Date: Jul. 7, 2011

(54) Method for Increasing the Popularity of Creative Projects and a Computer Server for its Realization

(76) Inventors: Elena Valerievna Papchenko, Saint Petersburg (RU); Alexey Vladimirovich Vorobyov, Saint Petersburg (RU)

(21) Appl. No.: 13/039,941

(22) Filed: Mar. 3, 2011

Related U.S. Application Data
(63) Continuation-in-part of application No. PCT/RU2009/000459, filed on Sep. 3, 2009.

(30) Foreign Application Priority Data
Sep. 3, 2008 (RU) RU2008136816

(51) Int. Cl. G06F 15/16

(52) U.S. Cl. 709/203

(57) ABSTRACT

Claimed is a method of collecting information containing the reaction of computer network users to creative projects content. The method includes locating information containing creative projects content on a computer server, the server comprising files of a website and being integrated into a computer network including at least one user computer. The method further provides the possibility of familiarizing with creative projects content and/or using creative projects content by a user from said at least one user computer using the interface of said website and the possibility of transferring information containing a user's reaction to a creative project content from said at least one user computer to said server using the interface of said website. Then a specific category of creative projects content units is determined by a selecting program block of the computer server based on a predetermined criterion and a list of creative project content units of said category is formed by said program block, such that at least a part of said list is accessible by at least one network user from at least one user computer.

### CROSS-REFERENCES TO RELATED APPLICATIONS

This application claims the benefits from International Application PCT/RU2009/000459 filed on Sep. 3, 2009 claiming priority from a national patent application RU 2008136816 filed on Sep. 3, 2008. The content of these applications is hereby incorporated by reference and in its entirety.

### FIELD OF INVENTION

The invention is related to methods for increasing the popularity of creative projects and, in particular, to methods for increasing the popularity of creative projects using Internet.

### BACKGROUND OF INVENTION

Increased level of integration between different regions and countries throughout the world results in a global nature of creative work. In particular, this leads to rapid development of show business and related fields. However, due to substantial costs needed for presenting a creative project to general public and increasing its popularity, only a few such projects became widely known.

The growth of Internet partially solved this problem. Authors of creative projects have had the opportunity to locate the content of their creative projects in Internet providing an access thereto for millions potential customers. However, in this case the author at least has to create a website for locating the outcome of his creative work and use methods for increasing the website traffic and citation index to ensure that the outcome of creative work is presented to many people. However, not all authors have proper technical skills to complete task. Besides, even the above-mentioned pieces of work are executed, the number of the website visitors is limited because the author and his creative work is unknown and therefore potential visitors cannot find this website by inputting, for instance, a required set of key words or symbols in a search engine.

The growth of social networks in Internet provided additional opportunities for presenting creative projects. A social network in Internet is a program service realized on a specific website providing interaction between people in a group or groups. The main feature of present-day services in this field is search tools for searching for and establishing needed contacts. By means of tools of a social network each user can form his virtual portrait—profile, and specify his personal details, work experience, hobbies, and purposes. The registration of a profile makes it possible to use tools for searching for like-minded persons. Examples of major Russian social networks are www.vkontakte.ru, www.rutube.ru, and examples of major worldwide networks are newgrounds.com, www.youtube.com, www.myspace.com. In www.mylivepage.ru network, a user can create a personal website with a forum, blog, photo gallery and chat and then integrate this website into a social network while using services of the network, such as tags, communities, friends etc.

A present-day social network permits users to locate at least images, music, texts and video materials thus ensuring musicians, artists, photographers, writers, etc. to increase the popularity of their creative projects. However, in a standard social network the above-mentioned facilities are limited, primarily because of its generality. Users consider such a network primarily as a tool for communicating with a group of people having common interests. A permanent circle of contacts of each user is restricted and amounts to from several dozens to several hundreds persons in spite of that the number of members of a social network can make up tens of millions. Therefore, the number of network users who can familiarize with an author's creative work will be approximately the same—no more than several hundreds. A group of fans of an author formed in a network can increase the number of such fans by several times. However, because simple and effective tools for promoting creative projects, selling the content of creative projects by authors, making profits from their creative projects by other ways, etc. are absent from a social network, using standard social networks for increasing the popularity of creative projects is inefficient.

In JP 2002049679, disclosed is a website intended for promoting projects by amateur musicians. On this website, an amateur musicians registers, create his profile using the interface of the site, the profile containing information about the musician and his music project. Further, the musician locates his music project or projects on the website, and visitors of the website can listen to music compositions of said projects and purchase records. Additionally, visitors can vote on specific music compositions.

It should be noted that information about the reaction of a visitor to a creative project content, a specific creative project content unit, e.g. a song, or an author is very important while promoting a creative project and facilitate to reveal preferences of potential audience. On the website of JP 2002049679, voting is executed on each creative projects content unit registered on the website and located in the database. As the number of units located on the website increases, the probability that enough amount of visitors will listen to a certain music composition considerably reduces. This leads to the situation when even potentially popular music composition wins few votes due to only few visitors have listened to it. On the one hand, this prevents a specific music composition, music project or author from reaching a potential level of popularity. On the other hand, the author cannot estimate the potential of his project because of little statistical sampling.

It also should be noted that a standard method of voting of visitors will not always provide impartial information about potential popularity of a project. This might result from possible partiality or unpredictable behavior of visitors, some of which, for instance, always underrate.

Thus, the website of JP 2002049679, though being a specialized tool for promoting music projects, nevertheless does not increase the popularity of a specific music project to its potential level and does not rate adequately a specific music project based on enough considerable statistical sampling.

### BRIEF SUMMARY OF THE INVENTION

The object of claimed inventions is providing a computer server integrated into a computer network, such that creative projects content can be located in said server, and the interface of said server provides the possibility of selecting specific creative projects content units for putting them to vote among units located in said server, so as to ensure a required number of facts of voting on selected content unit.

The object of claimed inventions is also providing a method for increasing the popularity of creative projects, a method of collecting information containing the reaction of computer network users to creative projects content and a method of rating a creative project content unit and/or a creative project and/or an author of a creative project that are met by using a server and provide an increasing the popularity of creative projects, obtaining the required number of facts of voting for specific creative projects content and forming an independent and appropriate rating of a specific creative project content and/or a creative project and/or an author of a creative project.

The aforesaid objects of the invention are accomplished by providing a server integrated into a computer network including at least one user computer, the server comprising at least a processor, software and a drive containing files of a website. The user interface of the website ensures directing information including creative projects content from said at least one user computer to said server, familiarizing with the creative projects content and/or using the creative projects content from said at least one user computer and sending information containing the user's reaction to the creative projects content from said at least one user computer to said server. The software of the server additionally includes a selecting program block adapted to determine a specific category of the creative project content units based on a predetermined criterion, and to form a list of the creative project content units of said category in such a manner that at least a part of said list is accessible by at least one network user from at least one user computer using said user interface.

The criterion of a specific category of the creative project content unit is, for example, the act of directing a command to pay for directing the information containing the reaction of at least one computer network user to said category of the creative project content units to the server. The command is directed from a user computer to the computer server.

Preferably, the program block is adapted to generate a command to transfer a payment to said at least one user for directing the information containing his/her reaction to at least one unit of said category of creative project content units from said at least one user computer to said server.

The website's interface usually ensures directing information on the amount of first unique users, to whom at least a part of said list should be accessible from at least one user computer. The part includes a specific creative project content unit from said category. Said information is directed for each unit of said category from said at least one user computer to the computer server.

Moreover, the program block is preferably adapted to provide access to at least a part of said list by second unique users from at least one user computer. This part includes said specific content unit, in absence of the act of directing information containing the reaction to said specific creative project content unit to the server by at least one of the first unique users. The amount of second unique users is equal to the amount of first unique users, for whom said act is absent during a predetermined period of time.

The creative project content can include music and/or texts and/or video files and/or images and/or flash applications.

The server's software is advantageously adapted to determine the price of a specific creative project content unit using a predetermined algorithm.

The objects of the invention are also accomplished by that in a method for increasing the popularity of creative projects including creating at least one webpage on a website by the author of a creative project using the interface of said website, files of the website being located on the computer server integrated into a computer network, the webpage containing information about the members of the creative project and/or the creative project and/or the creative project content, locating information containing creative projects content on said website using the interface of the website, familiarizing with the creative projects content and/or using the creative projects content by at least one computer network user from at least one user computer using the interface of the website and sending information containing the reaction of a user to the creative projects content from at least one said user computer to said server using the interface of the website, users forms modules on at least one webpage of said website, the modules representing creative projects content and/or creative projects and/or authors of creative projects.

Authors of creative projects preferably send information on prices for the content of their creative projects to the website, and offer the content of their creative projects for sale using the interface of the website, such that the visitors of said website can make the software of the server generate a command to transfer a payment for the content of a creative project by using said interface and then access the content of the creative project.

According to one aspect of the invention modules can be formed based on standard templates, such that the author can only change specific attributes of such module, including at least written content and/or background and/or image. According to another aspect of the invention said modules are completely formed by the author.

It is possible that the software of the server forms a hypertext marking which can be incorporated into the code of any webpage or wap-page, and the execution of said code provides visualization of the module containing information about the author and/or the creative project and/or the creative project content and adopting to ensure jumping to a webpage containing the information about the author and/or the creative project.

Each of at least two authors of creative projects preferably locates at least one module formed by the others of at least two authors on at least one webpage created by said author. As this takes place the software of the server locates said modules by incorporating a hypertext marking corresponding to said at least one module into the code of corresponding hypertext marking page.

It is possible for the author of a creative project to form a category of visitors of the website using the interface of the website, and to join said category, a visitor of the website directs a query from a user computer to the server using said interface, and the author, using said interface, can specify specific conditions of using the website resources related to said project for the visitors of the website who joined said category.

A communication session is usually realized on said server. The session is preferably created using the interface of said website on at least one predetermined webpage, the access to which by visitors of the website can be controlled by the author of a project. The session generally provides information on the creative project and/or at least one member of the creative project for at least one category of visitors of the website, and/or ensuring the exchange of such information between at least one member of the creative project and at least one category of visitors of the website. The communication session is realized at least by using text message exchange service (chat) and/or video broadcast and/or blogs and/or audio broadcast.

According to one aspect of the invention the communication session can be realized in such a manner that a visitor of the website can send information containing questions to the author to the website using the interface of the website, and the author can edit said information and send answers to said questions to the website using the interface of the website, and the author can stop the receipt of the information using said interface, the software of the website forming a region on the project webpage, said region containing questions edited by the author and answers thereto and being accessible by at least one category of visitors of the website.

It is possible for the author of a project to set an access fee for visiting the webpage, on which said communication session is realized using the interface of the website. In this case visitors of the website are able to access said webpage when the fee is paid using said interface. Moreover, the software of said website provides free access of specific categories of visitors of said website to said webpage based on validation of the identifier inputting by a visitor when entering the website.

It is advantageous that electronic wallets are created on said website for visitors of the website. Said wallets are controlled by the visitors using the interface of the website, the pay for at least the content of creative projects and/or the access to the paid webpages is executed using said wallets. In addition, the controls of electronic wallets of authors to the extent of controlling funds received by paying for the access to said webpage can be blocked for a certain period of time, during which visitors having access to said webpage can send information containing complaints regarding the quality and/or the content of information provided by means of said communication session to the website using the interface of the website, said information being analyzed, and according to the results of such analysis, said controls can be unblocked, or said funds can be completely or partially transferred back to the wallets of visitors having paid for the access.

The objects of the invention are also accomplished by that in a method of collecting information containing the reaction of computer network users to creative projects content, the method including locating information containing creative projects content on a computer server, the server comprising files of a website and being integrated into a computer network including at least one user computer, providing the possibility of familiarizing with creative projects content and/or using creative projects content by a user from said at least one user computer using the interface of said website and providing the possibility of sending information containing a user's reaction to a creative project content from said at least one user computer to said server using the interface of said website, a selecting program block of the computer server further determines a specific category of creative projects content units based on a predetermined criterion and forms a list of creative project content units of said category by said program block, such that at least a part of said list is accessible by at least one network user from at least one user computer.

The criterion for determining a specific category of creative project content units usually is the act of directing a command to pay for the information containing the reaction of said at least one user to said category of creative project content units. In this case the command is directed from a user computer to the computer server.

The method preferably includes generating a command to transfer a payment to said at least one user for directing the information containing his/her reaction to at least one unit of said category of creative project content units from said at least one user computer to said server, the command being generating by the software of the server.

It is advantageously to direct information on the amount of first unique users, to whom at least a part of said list should be accessible from at least one user computer, the part including a specific creative project content unit from said category. Said information is directed for each unit of said category from said at least one user computer to said computer server.

Access is usually provided to at least a part of said list by second unique users from at least one user computer. The part includes said specific content unit, in absence of the act of directing information containing the reaction to said specific creative project content unit to the server by at least one of the first unique users. In this case the amount of second unique users is equal to the amount of first unique users, for whom said act is absent during a predetermined period of time.

It is advantageous to send information containing parameters for selecting target audience among the computer network users in order to obtain its reaction to the content of a creative project and/or a creative project and/or the author of a creative project. The information is directed from at least one user computer to the server, a selecting software block of the server providing access to at least a part of said list for the target audience selected based on said parameters from at least one user computer.

In addition, the target audience is advantageously selected based on at least one of the following parameters: sex, age, educational status and field, location, social status, income level, hobbies, field of activity, involvement in their own creative projects and field thereof.

It is preferable to send information containing a list of questions for determining the reaction of said target audience to the content of a creative project and/or a creative project and/or the author of a creative project from at least one user computer to the server, a selecting program block of the server providing access to the information containing said list of questions for the target audience from at least one user computer. Further it is preferable to provide the possibility of sending information containing answers to said questions by a user from said at least one user computer to the server.

The objects of the invention are also accomplished by that in a method of rating a creative project content unit and/or a creative project and/or an author, including locating information containing creative projects content on a computer server, the server comprising files of a website and being integrated into a computer network including at least one user computer and providing the possibility of familiarizing with creative projects content and/or using creative projects content by a user from said at least one user computer using the interface of the website, a monitoring program block of said server collects information about a computer network user's behavior during his/her familiarizing with creative projects content and/or using creative projects content; and said program block rates the creative project content unit and/or the creative project and/or the author based on said information using a predetermined algorithm.

According to an aspect of the invention said program block collects information about the number of content units of a specific creative project with which a user has familiarized and/or used.

According to another aspect of the invention said program block collects information about facts of complete or incomplete familiarization with the creative project content by a user and/or complete or incomplete usage of the creative project content by a user, and about repeated familiarizations with the creative project content and/or repeated usages of the creative project content with a time interval between repeated familiarizations and/or usages, or with no interval.

According to another aspect of the invention said program block collects information about facts of copying the creative project content units by a user using the interface of the website after familiarizing with and/or using the creative project content.

According to another aspect of the invention said program block collects information about facts of jumping to a webpage of said website, the webpage containing detailed information about the creative project content unit and/or the creative project and/or the author, immediately after familiarizing with and/or using the creative projects content.

Said information about a user's behavior is advantageously sent to a database.

Said program block, when rating, can use an algorithm that further utilizes information containing the reaction of users to the creative projects content. The information is sent by said users from said at least one user computer to said server using the interface of the website.

According to an aspect of the invention said program block can use collected information to determine the price of a specific creative project content unit using a predetermined algorithm.

### BRIEF DESCRIPTION OF DRAWINGS

FIG. 1—a social network used for increasing the popularity of creative projects according to the present invention;

FIG. 2—diagram illustrating the interaction between an author of a creative project and other visitors of the website according to the present invention;

FIG. 3—diagram illustrating the creation of advertising modules on the website according to the present invention;

FIG. 4—diagram illustrating the interaction between an author of a creative project and other visitors of the website by means of a communication session;

FIG. 5—flowchart illustrating a method of collecting information containing the reaction of computer network users to creative projects content;

FIG. 6—flowchart illustrating a method of rating a creative project content unit.

### DETAILED DESCRIPTION OF THE INVENTION

A detailed description of preferred embodiments of the present invention will be set forth further with references to accompanying drawings.

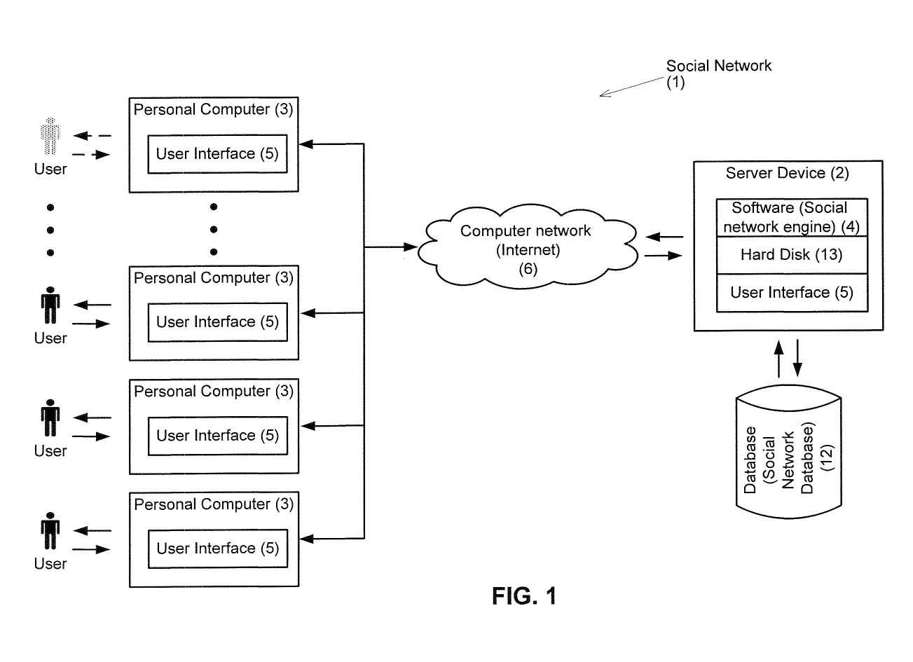

With reference to FIG. 1, a social network 1 comprises at least a server 2, a database 12 and user devices, e.g. user computers 3 connected to each other by means of a computer network 6. A social network organizes as a website is used for increasing the popularity of creative projects. Preferably, the network 6 is Internet, however, the invention is applicable for any other computer network, e.g. intranet.

It also shall be understood that said user devices can be any user devices which can be integrated into a computer network, e.g. cellular phone. The term “creative project” as uses herein refers to any project, the content of which can be presented by computer means.

The server 2 comprises at least a processor, software and a drive implemented as a hard drive 13 containing files of the website, by means of which the social network is organized. The website comprises a user interface 5. The interface 5 is adapted to send a creative project content from any user computer 3 to the server 2 and ensure familiarization with and/or usage of a creative project content from any computer 3.

The social network users can access to recourses of this network via a user computer by means of corresponding software and networking equipment, e.g. a modem or network interface controller.

Said website is used for providing the interaction between social network users and increasing the popularity of creative projects. The website is accessible for all computer network users or for a part of the users. To use recourses of the website entirely, a user should register in said website. The software 4 provides exchanging logic for exchanging information flows between elements of the social network and processing logic for processing this information. Upon registration of the network user on the website, the software 4 assigns unique access parameters to the user and authorizes the access of the user to corresponding recourses of the website based on said parameters.

The author of a creative project wishing to increase the popularity of his creative project also registers on the website. As used herein, the term “author of a creative project” refers to a social network user who is the only author of a creative project or a member of a creative project managing this project by means of said website. It should be noted that an author of a creative project can additionally assign an author status to other member or members of the creative project, such that said other members can manage the creative project by means of the website in full. In an alternate embodiment, the author can assign an author status to other member or members of the project, such that said other members have restricted access to the project management. In the above-mentioned cases, the project will have at least two members having an author status.

The software 4 creates a user profile for each network user registered on the website. The user profile is records in the database 12 of the social network 1. When a user enters the social network 1 and is authorized, the software 4, based on said records, forms profile pages of the user, and the user can view said pages from a user computer 3 using a browser. Users can edit their profiles by means of a page for managing a user profile. In particular, a user can limit access to pages of his profile for specific categories of the social network users and/or regulate the volume of accessible information. The profile contains information about actions which corresponding user can carry out on the website, e.g. blogging, and the user's personal details input on registration. If a user registers as an author of a project, the software 4 modifies the user profile providing for the user capacities to carry out additional actions, such as creating projects. On creating a project, the software 4 forms a project profile in the database 12 and a project page based on said profile. Authors of a project have access to the profile of their project and can edit it by means of a page for managing a project profile. Authors of project having corresponding profiles are allowed to carry out all actions with regard to a creative project management supported by the social network 1.

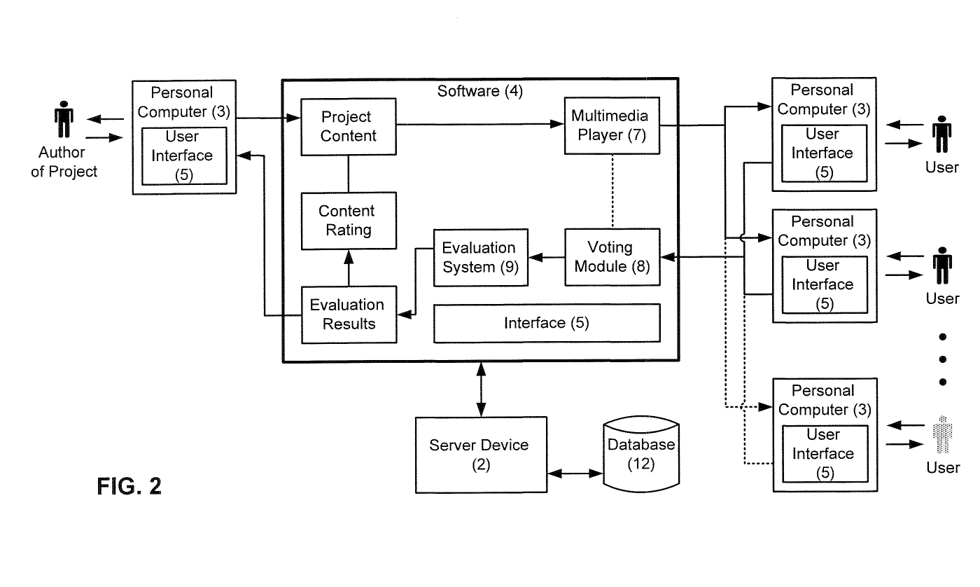

The structure of interaction between an author of a creative project and other visitors of the website is presented in FIG. 2.

After registration, the author of a project can create the project profile, the profile being records in the database 12 of the social network 1. The software 4, based on said records, forms pages of the project profile, the pages containing information about the project and being accessible for all network users or for specific categories of the network users, if the author limits access for said categories. Further, said pages can contain information about members of the project and/or specific creative project content units. As used herein, the term “creative project content units” refers to any part of said project which is a complete, separate object, e.g. a song.

The author sends the content of his creative project from any user computer 3 to the server 2 using the interface 5. The content can be a music composition, music album, literary work, any video files or images, flash applications and any combinations thereof. It should be noted that the above-mentioned objects only serve as illustrative examples and is not intended to limit the scope of the invention.

On the other hand, any network user having access to the server 2 from the user computer 3 by means of the network 6 can familiarize with and/or use a creative project content using the interface 5. For example, the interface 5 comprises a multimedia player 7 making it possible for the user to listen to music compositions or watch video files.

Creative projects located on the website are grouped into sections thus facilitating the search for objects corresponding to user's interests.

Each visitor of the website can send information containing his reaction to creative project content from any computer 3 to server 2 by means of the interface 5. Such reaction includes rating a creative project, e.g. by 5-mark grading system, and comments in free format. To this effect, the interface 5 comprises a voting module 8. By means of the module, visitors of the website can input their rating of a creative project and/or a creative project content unit or present a comment in free format in the edit field.

The software 4 comprises a data analysis system 9 for analyzing the reaction to creative projects content and/or creative projects content units obtained from visitors of the website based on a predetermined algorithm and for producing results of such analysis. The author of a creative project can view said results by means or the interface 5. The system 9 also rates a creative project content and/or the author of a creative project and/or a creative project content unit and, based on this rating, ranks each unit in at least one chart of the website.

By virtue of the interface 5, the author has ample opportunities to manage a project and popularize it by many ways.

The author can offer content units of his creative project for sale while establishing price at his discretion. For this purpose, the author sends information about content units he wish to offer for sale and desired price to server 2 using interface. Any user can make the software 4 generate a command to transfer a payment for the content unit from a computer 3 using interface 5 and then load corresponding unit to his computer after paying. To ensure transactions between the author and other visitors of the site, electronic wallets, well-known from the prior art, are formed on the website.

The software 4 also estimates a potential value of a creative project unit for consumers and determines a recommended price for each unit based on a predetermined algorithm. The algorithm uses different parameters influencing the price, such as the unit rating, the popularity of the genre, etc. The author of the creative project can learn the recommended price using the interface 5. Then the author can establish the price, such that it is equal to the recommended one or establish his own price.

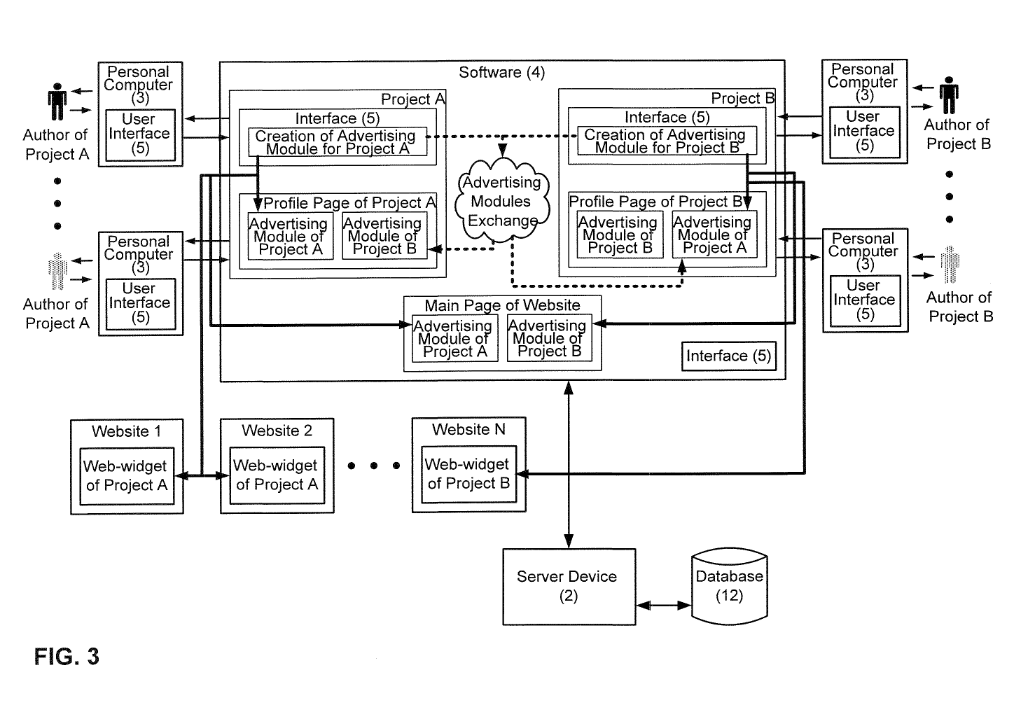

Authors also can form advertising modules presenting a project and/or a the author of a project and/or a creative project content units and locate such modules on the website by means of the interface 5. The modules can be universal or unique. The modules are formed in a specialized region on the page for managing a project. The process of forming the modules is illustrated in FIG. 3.

To form an advertising module, the author of a project enters a specialized page of the website used for forming modules. To permit access to said page, the software 4 authorizes a user. If the authorization is successful, the software 4 permits the user to access to said page, and otherwise the software 4 denies access. Further, the author forms an advertising module using the interface 5.

Universal modules use standard templates, and the author only controls attributes of the module, including text, background or image.

To form a universal module, the author selects the project, the content of which he wishes to advertise, from the drop-dawn list of all his projects of said specialized region. Further, the author inputs the advertising text into an edit field, and then selects the begin and end date of the module exhibition and the pages to locate said module on, e.g. the profile page. Modules formed by different authors and/or different modules formed by the same author can interchange with a certain rate, e.g. using flash-technology or gif-animation.

When forming a unique module, the author selects a project, the content of which he wishes to advertise, and the subject of the module, e.g. album issue, from corresponding drop-dawn lists. Further, the author selects attributes of the module, such as the color of the background, font size and color.

The author inputs the title and the advertising text into an edit field. Hyperlinks can be made of a part of the text, the author selecting the page, where said hyperlink refers to, in a compo box comprising pages of all his projects.

Then the author selects the image to be located in the module. The software 4 forms a collection of images for the current project, the collection including at least the author icon, the project icon and images of corresponding subject. For instance, if the module is dedicated to new album issue, the images are associated with music. Besides, loading the user's images is possible.

After inputting texts and selecting the image, the author can preview the module.

After that, the author selects the type of the module, i.e. static or dynamic, that is interchanging at a certain rate; begin and end date and pages on which the module to be displayed, e.g. the project profile page; the number of exhibitions per day. It should be noted that the above-mentioned sequence of operations depict only illustrative example of forming a unique module. Such a module can comprise other elements, e.g. videos or flash-applications.

In an alternative embodiment, web-widgets are one more means for popularizing a creative project. A web-widget is a visualized module that can be formed on any web- and/or wap-page, e.g. on web-pages of websites 1, 2 . . . N in FIG. 3, by referencing to a server, separate elements of said module being stored on the server and the software of the server controlling forming of said module, using hypertext markup. In a preferred embodiment, the hypertext markup, which can be incorporate into the program code of any web- or wap-page, is formed by the software 4. Execution of said code ensures visualization of the advertising module. By activating said module, e.g. using a mouse, a jump can be carried out to a page of the website on which the social network is realized, the page containing information about the advertised creative project and/or the author of the creative project and/or the creative project content unit.

On the website, authors can also exchange advertising modules locating the modules of each other on their pages (FIG. 3). To locate said modules, the software 4 integrates hypertext markup corresponding to the advertising module into program code of corresponding page.

By forming advertising modules of desired kind containing desired information, selecting the website pages the modules to be displayed on, and further distributing the modules by means of web-widgets and exchange, authors of projects can effectively present the content of their projects to target audience in clear form, thus facilitating the popularization of the project.

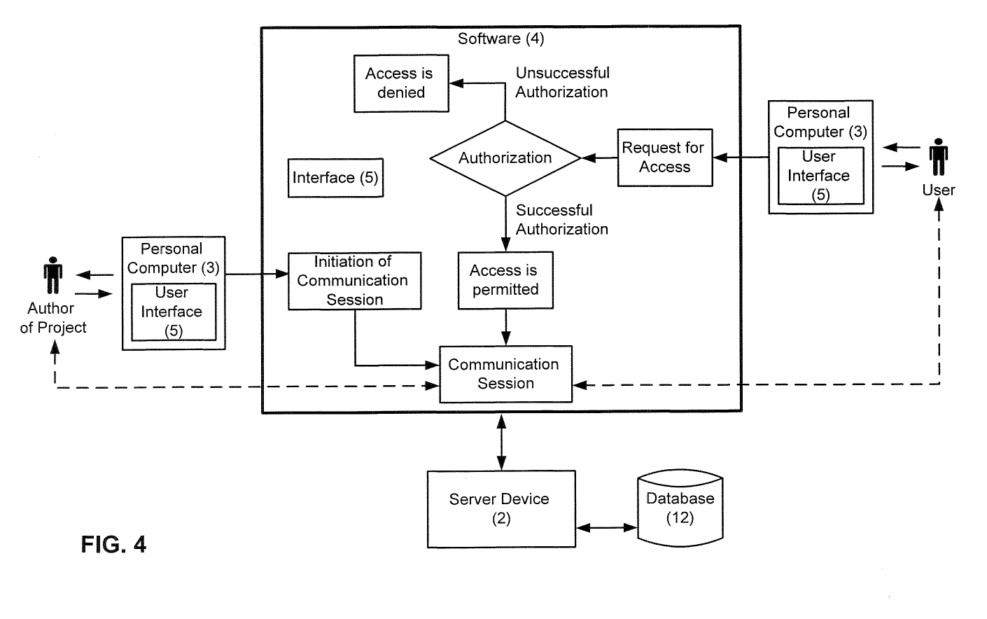

On the website according to the invention, a communication session can be realized (FIG. 4).

A communication session can be realized on at least one specialized page of the website, the access to said page being controllable by the author of the project. A communication session provides information associated with a creative project and/or least one member of a creative project to at least on category of visitors of the website, and/or exchange of such information between, on one side, at least one member of a creative project and, on other side, at least one category of visitors.

In one embodiment, access of visitors of the website to the page of a communication session is paid. The access fee is established by the author of the project by means of the interface 5. The visitors pay for access also by means of the interface 5, and then can access to the page of the communication session. For mutual payments, visitors can create personal electronic wallets on the website using the interface 5. The author of a creative project also can create an electronic wallet to receive fund earned by his creative project.

For example, a visitor of the website can pay for access to said page by transferring corresponding sum from his wallet to the project wallet created by the author. The software 4 forms a list of identifiers of those visitors who have paid. When a visitor tries entering the page of a communication session, the software 4 authorizes the visitor and check if he has access right to this page. If he has, the software 4 permits him to access, otherwise the software 4 denies access.

Besides, the author can establish free access to said page for specific categories of visitors of the website, e.g. for members of the author fan club or project fan club. A fan club is a category of visitors of the website, the visitors sending information containing a query for joining the fan club from a user computer 3 to server 2. Further, the visitor pays for the membership in the fan club using the interface 5. The software 4 puts the visitor's identifier on the list of identifiers of visitors of this category. The author of a project can start forming a fan club and establish preferences and special terms when using resources of the website related to the project for the author fan club and/or the project fan club members by means of software 4.

To establish free access to the page of communication session for specific categories of visitors using the interface 5, the author of a project forms a list of such categories. Further, when a visitor tries entering said page free of charge, the software 4 authorizes this visitor. When authorizing the visitor, the software 4 checks if he is included in at least one of said categories. If the visitor is included in at least one of said categories, the software 4 permits his to access to this page, otherwise the software denies access.

In particular, an author can start communication with visitors of the website by text message exchange service (chat) for increasing the popularity of his project and the loyalty of audience.

For this purpose, in a specialized region of the page for managing the project, the author inputs the title, description, and subject of the chat, the name of the project member to take part in the chat, time and date of the chat, and, if desired, establish a fee for entering the chat page.

The page comprises two chat windows, one of which is intended for announced project member. Other user can chat with him in real-time mode.

Furthermore, a communication session can be video broadcasts from shows, rehearsals and other activities, in which the members of a project participate or which are related to the project and/or project members.

The page of a video broadcast comprises a multimedia player playing information from video cameras in a predetermined time in real-time mode.

The page can additionally comprise elements of communication sessions of other kinds, e.g. chat or comment fields.

A communication session can also be a blog of at least one member of a creative project.

A communication session can also be an interview-session, during which visitors of the website can ask questions to a member of a creative project.

To form an interview-session, the author pushes a button on the page for managing a project and jumps to the page for forming an interview-session. In the page, the author inputs the title, subject and brief description of the interview session in specialized regions, and, if desired, adds an image for illustrating. Further, the author selects a project member to participate in the interview session from a drop-dawn list.

The author can also select the category of visitors of the website accessed to participating in the interview session, e.g. the fan club members, or make it accessible for all visitors.

The author can actuate automatic distribution of invitations for the interview-session for specific categories of visitors, e.g. the fan club members. Such distribution is carried out by the software 4.

The above-mentioned universal or unique advertising modules can be formed for advertising the interview-session.

After specifying all parameters of the interview session, the author pushes the “apply” button in order to run the interview-session. If an automatic distribution of invitations for participating in the interview-session to specific categories of visitors was actuated, the software 4 carries out such distribution. In the same time, the software 4 displays information about the interview-session on the project page.

Each visitor of the web-site or visitors from the category selected by the author can ask one or more questions.

The author can see all the questions and can answer them, edit them or delete those he does not like.

The interview-session can be closed in a period of time predetermined by the author or manually by the author.

When the interview-session is over, the software 4 forms a region on the author page comprising the interview in “question of visitor—answer of project member” format. Said region is accessible for at least one category of visitors of the website.

In one embodiment, electronic wallets are adapted to be blocked by the website administration and/or automatically. During a communication session, an electronic wallet is automatically blocked for 24 hours to the extent of funds transferred to this wallet by visitors of the website for the access to the page of communication means. A visitor of the website having complaints about the quality and/or content of said communication session can push the “inform moderator” button placed on the page of the communication session and set forth his complaints. The moderator considers the complaints and makes decision with regard of their foundation.

In absence of complaints during 24 hours or if the complaints are unfounded, the project wallet is automatically unblocked. If the complaints are founded, the moderator has the right to return money partially or in full to visitors of the website filed complaints.

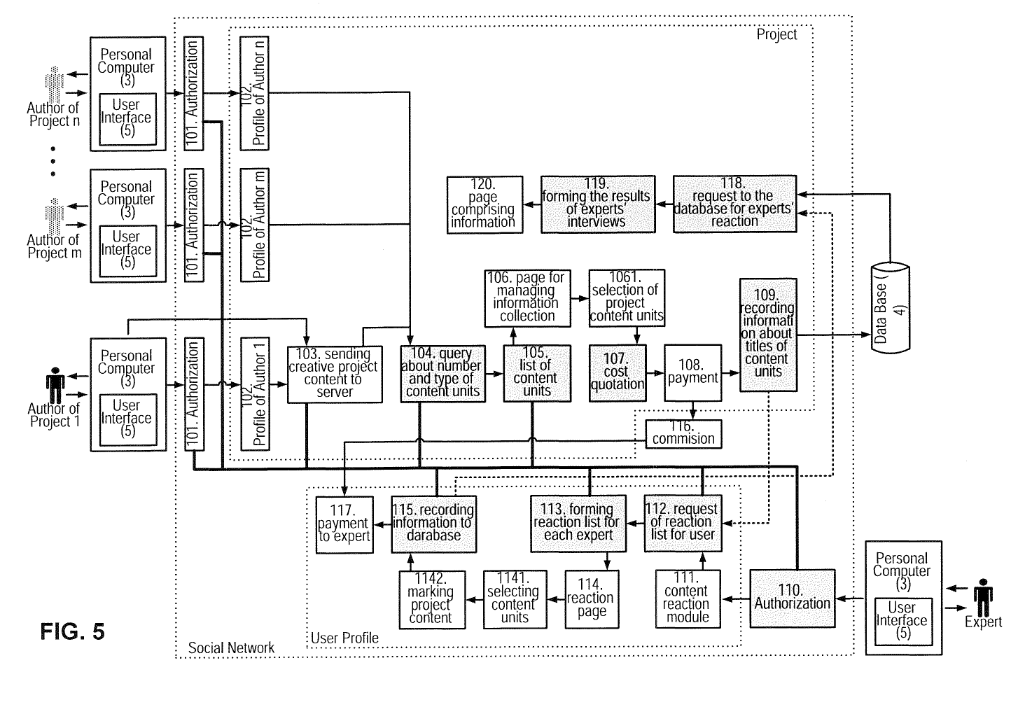

In one embodiment, a method of collecting information containing the reaction of users to creative projects content is provided. The method is shown in FIG. 5.

To obtain a needed number of reaction facts on selected creative project content units, the author requests the access to the page for managing the project profile from a user computer 3. Referring to FIG. 5, n creative project members have an author status, and therefore can manage the project by means of the interface 5. On stage 101, when a user tries entering the page for managing the project profile, the software 4 authorizes the user and checks if he has an author status for this creative project. If the user has an author status, the software 4 permit him to access to said page (stage 102), otherwise the software 4 denies access.

On stage 103, the author of the project sends the creative project content to the server 2 using interface 5.

On stage 104, the author can direct a query about the number and type of content units for current project to the database 12 using the interface 5.

On stage 105, the software 4 forms a list of content units related to current project by interrelating with the database 12.

To form a list of content units, on which the author wishes to obtain a certain number of reaction facts, on stage 106, the author enters the page for managing information collection. On stage 1061, on said page, the author selects project content units, on which he wishes to obtain reactions facts. Further, he specifies desired parameters against each of selected content unit, such as the number of reaction facts, obtaining reaction of a specific target group, etc.

Further, on stage 107, the software 4 determines the order cost as: order cost—(number of reaction facts)*(cost per 1 reaction fact). On stage 108, the author directs a command to pay for the order to the server 2 using the interface 5. For instance, the order can be paid by transferring corresponding sum from the electronic wallet of the project.

After paying for the order, the software 4 records information about titles of content units selected by the author for obtaining reaction facts, the number of required reaction facts for each of said content units and other parameters specified by the author in the database 12. The software 4 provides access to at list a part of the list of selected content units for network users having an expert status. The experts are users who filled in an expert questionary when registering on the website or in any other time after registering using the interface 5. An expert can familiarize with and/or use a creative project content using the interface 5. For example, the interface 5 comprises a multimedia player 7. An expert can listen to music compositions or watch video files using the player 7.

When a user tries accessing to an expert profile from a computer 3, on stage 110, the software 4 authorizes the user and checks if he has an expert status for this creative project. If the user has an expert status, the software 4 permit him to access to said expert profile, otherwise the software 4 denies access.

After accessing to the expert profile, on stage 111, the expert runs a creative project content reaction module from the managing page. On stage 112, the software 4 directs a request to obtain the reaction list for the user to the database 12. This list includes at least a part of the list of titles of content units selected by the author on stage 1061. On stage 113, the software 4 forms the reaction list for each expert according to a predetermined algorithm. The algorithm, in particular, is based on each expert preferences related to the type and genre of creative projects, average time needed for the expert to react, etc. Each expert can view his personal reaction list from a user computer 3.

To direct information containing the reaction of the expert for creative project content to the server 2, on stage 114, the examiner enters the reaction page. Then, on stage 1141, the expert selects content units, reaction to which he wishes to direct to the server 2, from the reaction list using the interface 5. On stage 1142, the expert inputs his mark for a project content unit and/or a comment in free format in an edit field and directs his marks and/or comments to server 2 using voting module 8 of the interface 5.

On stage 115, the software 4 directs information containing the expert's reaction to creative project content to database 12.

Experts are paid for directing information containing their reaction to creative project content from the reaction list to the server 2 by transferring funds to their electronic wallets. For this purpose, on stage 116, the software 4 determines a commission based on a predetermined algorithm and subtracts the commission from the order cost determined on stage 107. On stage 117, the software 4 generates a command to pay to the expert for the reaction fact, the value of the payment being determined as a subtraction of the sum obtained on stage 107 and the commission.

Experts also can direct information containing their reaction to creative project content to the server 2 without earning money. For this purpose, the software 4 forms a reaction list containing content units, reaction facts on which have not paid by their authors, in the reaction module. For instance, this can be realized for novice authors.

The software 4 also forms a reaction fact counter for each content unit. The value of the counter varies from 0 to N, where N is the paid number of reaction facts.

The software 4 locates content units having the counter value of 0 on the first row of the reaction list formed for each expert. The less is the counter value, the closer is the content unit to the top of the reaction list. On the other hand, the earlier is the reaction fact ordered, the closer is corresponding content unit to the top of the reaction list.

In one embodiment, the software 4 filters the list of experts according to their activity level in two stages. On the first stage, the software 4 fixes experts who have not visited the website for a predetermined period of time, e.g. a month, and excludes such experts from the list of active experts. On the second stage, the software 4 fixes experts visiting the website but not voting for a predetermined period of time, e.g. 10 days, and excludes such experts from the list of active experts. The software 4 does not form reaction lists for inactive experts and include them to the list of experts for obtaining reaction facts to content units. An expert can renew an active expert status by jumping on a specialized link generated by the software 4.

In one embodiment, when an author specifies a total number of desired reaction facts on a specific content unit, the software 4 counts a total number of active expert registered on the website. If said number is more or equal to the number of desired reaction facts, the software 4 forms a reaction list for corresponding experts, otherwise displays an error message.

In one embodiment, an expert can filter content units according to his preferences. In this embodiment, the expert can filter the voting list according to his preferences by means of the interface 5 using the software 4. For example, he can select different types of content units, such as music or video, or genre within a specific genre, e.g. rock or blues. For this purpose, on running the reaction module, after the expert has pushed “vote” button, the software 4 forms a filter interface. By means of said filter interface, the expert makes his choice. Then, the software 4 refers to the database 12 for determining types, genres etc. of content units, on which reaction facts are ordered, and forms a reaction list for a specific expert based on the analysis of this information.

As soon as the value of the reaction fact counter reaches N, the software 4 excludes corresponding content unit from reaction lists of all experts.

If an expert's reaction to a content unit from his reaction list is not received in a predetermined period of time, the software 4 excludes this unit from the reaction list of this expert and brings it to the reaction list of other expert, thus providing swiftly obtained desired number of reaction facts on all selected content units.

On stage 118, to provide an author with information about experts' reaction to content units selected by him, the software 4 refers to the database 12 with respect of experts' reaction.

On stage 119, the software 4 forms the results of experts' interviews, including rating calculated according to a predetermined algorithm, in a convenient form.

On stage 120, the author views the page comprising information containing experts' reaction from a computer 3.

According to the above method, a desired number of reaction facts on any creative project content unit can be obtained. This will increase the popularity of said content unit and/or project and/or author and provide needed statistical sampling to estimate the potential of said content unit.

When forming charts for different categories of creative projects on a website, it is a matter of crucial importance for a creative project that it is situated in the field of vision of the chart, i.e. close to the top of the chart. This field is primarily visible for a visitor of the website when he enters the chart page. When a project is situated at the top of the chart, it is not only an indicator of the project's popularity. This also ensures additional popularization of the project owing to permanent visual availability of information about the project for potential customers. This, in turn, ensures more references to the website pages related to the project by visitors of the website, more acts of listening to and/or watching and/or using the project content, more free reaction facts and, therefore, maintenance and increase of the project rating. However, if a creative project is situated beyond the field of vision of the chart, even potentially popular project will have low rating because of insufficient number of reaction facts. The above method for collecting information containing the reaction of computer network users to creative projects content permits an author to regulate the number of reaction facts on a project and, correspondingly, situate potentially popular project in the field of vision of a chart.

In one embodiment, an author can filter experts according to his preferences. In particular, the author can specify a target audience to obtain its reaction for creative project content. For this purpose, on stage 1061, on the page for managing information collection, the author can select the target audience according to at least sex, age, educational status and field, location, social status, income level, hobbies, field of activity, involvement in their own creative projects and field thereof.

Then, the software 4 records information about needed target audience in the database 12 and compares this information with information about experts stored in the database 12. If an expert's details match with the needed target audience, the software 4 adds corresponding content units to reaction lists for corresponding experts, otherwise displays an error message.

The software 4 provides access to at least a part of the list containing creative project content units selected by the author for experts of the target audience selected by the author. The software 4 refers an expert to a certain target audience on his registering as an expert and filling in corresponding questionary. In the questionary, an expert gives personal details, which makes it possible to refer him to a certain target audience. The software 4 additionally appraises behavior and preferences of experts, e.g. favorites on the profile page, friend list etc, in order to improve personal details and monitor preference change to refer an expert more precisely to a certain target audience.

In one embodiment, on stage 1061, an author can compose a questionary containing his questions about the reaction of target audience. The software 4 provides access to said questionary for corresponding target audience on the reaction page (stage 114). The experts received said questionary direct their answers to the questions of the questionary to the server 2 using the interface 5.

It should be understood that using this method for collecting target audience reaction is not limited to collecting target audience reaction to creative project or creative project content unit. In particular, the method can be used in interviews and marketing research.

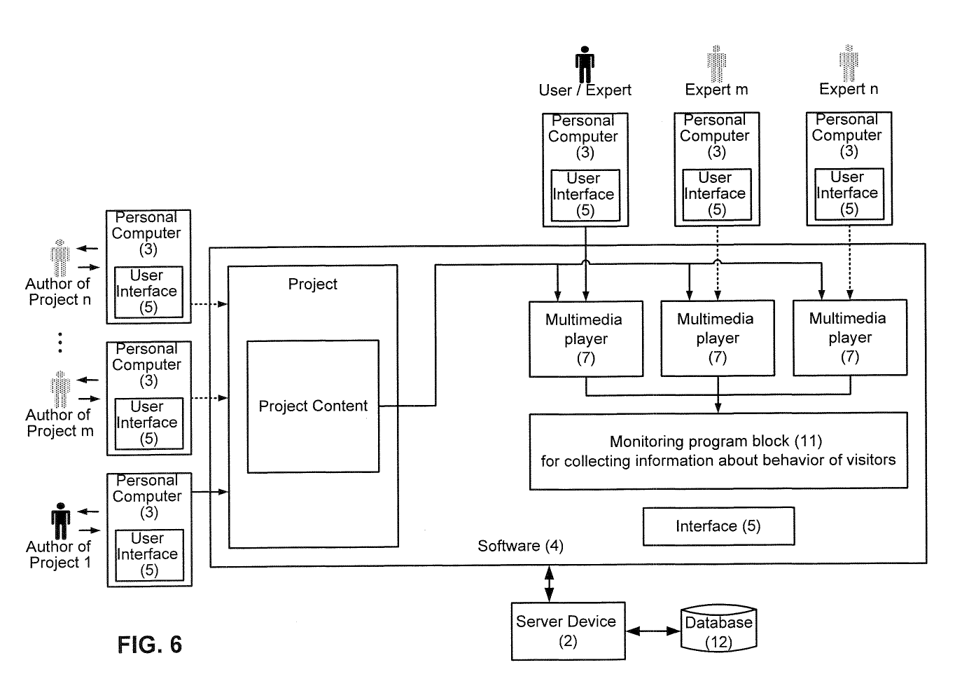

In one embodiment, provided is a method of rating a creative project content unit, shown in FIG. 6.

The method appraises behavior of a visitor of the website while familiarizing with and/or using creative project content.

In one embodiment, the multimedia player 7 used by a user for listening to and/or watching and/or using a creative project content unit before ranking it, is connected with monitoring program block 11 for collecting information about behavior of a visitor of the website (FIG. 6). Block 11 collects complete information about behavior of a user during his listening to and/or watching and/or using a creative project content unit, processes this information and directs it to the database 12. The block 11 collects full statistics related to the number of listened to and/or watched and/or used content units, duration of their listening to and/or watching and/or using, facts of complete or incomplete listening to and/or watching and/or using, facts of repeated listening to and/or watching and/or using, facts of jumping to the content unit load and/or purchase page or the page containing detailed information about the project and/or project content unit and/or author of the project immediately after listening to and/or watching and/or using.

The software 4 processes above-mentioned information according to a predetermined algorithm in order to rate the creative project content unit and/or creative project and/or author of the creative project.

It should be noted that, for rating, marks and comments inputted by visitors of the website can also be used.

It should be appreciated that embodiments of the invention described in detail in this specification serve as examples and are not intended to restrict the scope of the invention. Spirit and scope of the present invention are defined by accompanying claims.

I claim:

1. A server integrated into a computer network including at least one user computer, the server comprising at least
a processor,
a software and
a data storage containing files of a website, the user interface of the website comprising
means for directing data comprising information including creative projects content from said at least one user computer to said server;
means for providing access for at least one user to the creative projects content from said at least one user computer;
means for sending data comprising information on the user's reaction to the creative projects content from said at least one user computer to said server,
the server additionally includes
a selecting program block determining a category of the creative project content units upon receipt of a command related to a specific content unit from the at least one user computer by at least one first user having a unique access parameters to the website,
a compiler unit compiling at least one list of the creative project content units of said category, wherein the list contains said specific content unit and is accessible from the at least one user computer for a preset number of primary second users having unique access parameters to the website different from said access parameters of said at least one first user,
wherein the interface further comprises a number presetting unit for presetting said number of primary second users by the at least one first user from the at least one user computer.

2. The server according to claim 1, wherein said command is a command to pay for directing data comprising the information on the reaction of at least one computer network user to said category of the creative project content units to the server, the command being directed from a user computer to the computer server.

3. The server according to claim 2, wherein said selecting program block generates a command to transfer a payment to said at least one user for directing data comprising the information on his/her reaction to at least one unit of said category of creative project content units from said at least one user computer to said server.

4. The server according to claim 1, wherein said selecting program block provides access from at least one user computer to the at least one list containing said specific content unit for secondary second users having unique access parameters to the website different from said access parameters of said at least one first user in absence of the act of directing data comprising the information on the reaction to said specific creative project content unit to the server by at least one of the primary second users, the amount of said secondary second users being equal to the amount of primary second users for whom said act is absent during a predetermined period of time.

5. The server according to claim 1, wherein the creative project content includes at least music and/or texts and/or video files and/or images and/or flash applications.

6. A server according to claim 1, wherein the server includes a price determining unit determining the price of a specific creative project content unit using a predetermined algorithm.

7. A method of collecting data comprising information on the reaction of network users to creative projects content, the method including:
locating data comprising information containing creative projects content in a computer server, the server comprising at least a processor, a software and a data storage containing files of a website, and the server being integrated into a computer network including at least one user computer;
providing the access from said at least one user computer to the said data comprising information containing creative projects content using the interface of said website;
sending data comprising information on a user's reaction to a creative project content from said at least one user computer to said server using the interface of said website,
determining a category of the creative project content units upon receipt of a command related to a specific content unit directed to the server from the at least one user computer by at least one first user having a unique access parameters to the website;
presetting from the at least one user computer by the at least one first user a number of primary second users having unique access parameters to the website different from the access parameters of the at least one first user; and
compiling at least one list of the creative project content units of said category, the list containing said specific content unit and being accessible for a preset number of primary second users from the at least one user computer by means of the interface of the website.

8. The method according to claim 7, wherein said command is a command to pay for the information on the reaction of said at least one user to said category of creative project content units, the command being directed from a user computer to the computer server.

9. The method according to claim 8, wherein the method further includes generating a command to transfer a payment to said at least one user for directing data containing the information on his/her reaction to at least one unit of said category of creative project content units from said at least one user computer to said server.

10. The method according to claim 7, wherein the method includes providing access from the at least one user computer to the at least one list containing said specific content unit for secondary second users having unique access parameters to the website different from said access parameters of said at least one first user in absence of the act of directing information on the reaction to said specific creative project content unit to the server by at least one of the primary second users, the amount of said secondary second users being equal to the amount of primary second users for whom said act is absent during a predetermined period of time.

11. The method according to claim 7, wherein the method includes sending data containing parameters for selecting target audience among the computer network users in order to obtain their reaction to the content of a creative project and/or a creative project and/or the author of a creative project, the information being directed from at least one user computer to the server, wherein the access is provided to at least one said list from at least one user computer for the target audience selected based on said parameters.

12. The method according to claim 11, wherein the target audience is selected based on at least one of the following parameters: sex, age, educational status and field, location, social status, income level, hobbies, field of activity, involvement in their own creative projects and field thereof.

13. The method according to claim 11, wherein the method further includes sending data containing a list of questions for determining the reaction of said target audience to the content of a creative project and/or a creative project and/or the author of a creative project from at least one user computer to the server, providing access to the data containing said list of questions for the target audience from at least one user computer, and sending data containing answers to said questions by a user from said at least one user computer to the server.

14. A method of rating a creative project content unit and/or a creative project and/or an author of a creative project, the method including
locating data comprising information containing creative projects content in a computer server, the server comprising at least a processor, a software and a data storage containing files of a website and the server being integrated into a computer network including at least one user computer;
providing access for a user from said at least one user computer using the interface of the website to familiarize the user with the said creative projects content,
collecting by means of a monitoring program block of said server data comprising information on a computer network user's actions taken by means of specific blocks of the interface of said server during his/her familiarizing with creative projects content, wherein
the monitoring program block is connected with corresponding block of the interface for collecting said information on a computer network user's actions,
analyzing the collected information on a computer network user's actions by means of said monitoring program block to rate the creative project content unit and/or the creative project and/or the author of the creative project based on said information on a computer network user's actions.

15. The method according to claim 14, wherein collecting said data includes collecting data comprising information on the number of content units of a specific creative project with which a user has familiarized.

16. The method according to claim 14, wherein collecting said data includes collecting data comprising information on facts of complete or incomplete familiarization with the creative project content by a user and on repeated familiarizations with the creative project content with a time interval between repeated familiarizations or with no interval.

17. The method according to claim 14, wherein collecting said data includes collecting data comprising information on facts of copying the creative project content units by a user using the interface of the website after familiarizing with the creative project content.

18. The method according to claim 14, wherein collecting said data includes collecting data comprising information on facts of jumping to a webpage of said website, the webpage containing detailed information on the creative project content unit and/or the creative project and/or the author of the creative project, immediately after familiarizing with the creative projects content.

19. The method according to claim 14, wherein the method includes sending said information on a user's actions to a database.

20. The method according to claim 14, wherein said program block, when rating, uses an algorithm that further utilizes information on the reaction of users to the creative projects content, the information being sent by said users from said at least one user computer to said server using the interface of the website.

21. The method according to claim 14, wherein the method includes determining the price of a specific creative project content unit based on the collected information using a predetermined algorithm.
